(19) United States
(12) Patent Application Publication
(10) Pub. No.: US 2021/0334623 A1
(43) Pub. Date: Oct. 28, 2021

(54) NATURAL GRAPH CONVOLUTIONS

(71) Applicant: QUALCOMM Incorporated, San Diego, CA (US)

(72) Inventors: Pim De Haan, Amsterdam (NL); Taco Sebastiaan Cohen, Amsterdam (NL); Max Welling, Bussum (NL)

(21) Appl. No.: 17/239,580

(22) Filed: Apr. 24, 2021

Related U.S. Application Data
(60) Provisional application No. 63/015,281, filed on Apr. 24, 2020.

(51) Int. Cl. G06N 3/04; G06F 16/901

(52) U.S. Cl. CPC G06N 3/04; G06F 16/9024

(57) ABSTRACT

A method for generating a graph convolutional network includes receiving a graph network comprising nodes connected by edges. A node neighborhood is determined for each of the nodes of the graph network and an edge neighborhood is determined for each of the edges of the graph network. The node neighborhood for each of the nodes and the edge neighborhood for each of the edges are classified based on isomorphism. A mapping of a kernel from an edge neighborhood class representative to each of the edges of the graph network is determined. The graph convolutional network is generated based on the kernel mapping.

### CROSS-REFERENCE TO RELATED APPLICATION

The present application claims the benefit of U.S. Provisional Application No. 63/015,281, filed on Apr. 24, 2020, and titled “NATURAL GRAPH CONVOLUTIONS,” the disclosure of which is expressly incorporated by reference in its entirety.

### FIELD OF DISCLOSURE

Aspects of the present disclosure generally relate to graph symmetry networks.

### BACKGROUND

Artificial neural networks may comprise interconnected groups of artificial neurons (e.g., neuron models). The artificial neural network may be a computational device or represented as a method to be performed by a computational device. A graph neural network is a type of artificial neural network that operates on data that is represented as a graph. Graph neural networks (GNNs) may be used for reasoning. GNNs may be applied for other tasks in addition to, or alternate from, reasoning.

In contrast to conventional neural networks, graph neural networks retain a state that represents information from its neighborhood. More specifically, a signal of a GNN resides on a graph. A convolution of a signal provides an output at each node, where the output is a function of the signal at the neighbors in the graph. Multiple convolutions may be applied to the graph, such that the signal may depend on the neighbors of a neighbor. Over time, the signal is propagated step by step. In contrast, a feed-forward neural network has no notion of an underlying graph.

GNNs may be invariant or equivariant. In conventional GNNs, equivariance is obtained by setting each layer as a message passing layer, where the output is invariant to permutation of the messages. Such invariant message passing layers may limit GNN performance. It is desirable to achieve equivariance while improving performance of the GNN.

### SUMMARY

The present disclosure is set forth in the independent claims, respectively. Some aspects of the disclosure are described in the dependent claims.

According to an aspect of the present disclosure, a method includes receiving a graph network comprising nodes connected by edges. The method also includes determining a node neighborhood for each of the nodes of the graph network and an edge neighborhood for each of the edges of the graph network. The method also includes classifying the node neighborhood for each of the nodes and the edge neighborhood for each of the edges based on isomorphism. The method also includes determining a mapping of a kernel from an edge neighborhood class representative to each of the edges of the graph network. The method further includes generating a graph convolutional network based on the mapping.

In another aspect of the present disclosure, an apparatus includes a processor, memory coupled with the processor and instructions stored in the memory and operable, when executed by the processor, to cause the apparatus to receive a graph network comprising nodes connected by edges. The apparatus also determines a node neighborhood for each of the nodes of the graph network and an edge neighborhood for each of the edges of the graph network. The apparatus also classifies the node neighborhood for each of the nodes and the edge neighborhood for each of the edges based on isomorphism. The apparatus also determines a mapping of a kernel from an edge neighborhood class representative to each of the edges of the graph network. The apparatus further generates a graph convolutional network based on the mapping.

In another aspect of the present disclosure, an apparatus includes means receiving a graph network comprising nodes connected by edges. The apparatus also includes means for determining a node neighborhood for each of the nodes of the graph network and an edge neighborhood for each of the edges of the graph network. The apparatus also includes means for classifying the node neighborhood for each of the nodes and the edge neighborhood for each of the edges based on isomorphism. The apparatus also includes means for determining a mapping of a kernel from an edge neighborhood class representative to each of the edges of the graph network. The apparatus further includes means for generating a graph convolutional network based on the mapping.

In another aspect of the present disclosure, a non-transitory computer-readable medium with non-transitory program code recorded thereon is disclosed. The program code is executed by an apparatus and includes program code to receive a graph network comprising nodes connected by edges. The program code also includes program code to determine a node neighborhood for each of the nodes of the graph network and an edge neighborhood for each of the edges of the graph network. The program code also includes program code to classify the node neighborhood for each of the nodes and the edge neighborhood for each of the edges based on isomorphism. The program code also includes program code to determine a mapping of a kernel from an edge neighborhood class representative to each of the edges of the graph network. The program code further includes program code to generate a graph convolutional network based on the mapping.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor, in accordance with certain aspects of the present disclosure.

FIG. 2 is a block diagram illustrating an exemplary software architecture that may modularize artificial intelligence (AI) functions, in accordance with aspects of the present disclosure.

FIGS. 3 and 4 are diagrams illustrating examples graphs, in accordance with aspects of the present disclosure.

FIG. 5 is an example symmetric graph, according to aspects of the present disclosure.

FIGS. 6A, 6B, 6C, and 6D illustrate examples of node neighborhoods, in accordance with aspects of the present disclosure.

FIG. 7 illustrates an example of isomorphic node classes based on a graph, in accordance with aspects of the present disclosure.

FIG. 8 illustrates an example of isomorphic edge classes based on a graph, in accordance with aspects of the present disclosure.

FIG. 9 illustrates an example of a labelling of a neighborhood of two nodes, in accordance with aspects of the present disclosure.

FIG. 10 illustrates an example of a matrix for switching symmetries, in accordance with aspects of the present disclosure.

FIG. 11 illustrates an example of transporting a kernel, in accordance with aspects of the present disclosure.

FIGS. 12 and 13A illustrate examples of graph canonization, in accordance with aspects of the present disclosure.

FIG. 13B is a diagram illustrating a graph, in accordance with aspects of the present disclosure.

FIG. 14 illustrates a flow diagram for a method, in accordance with aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art.

Based on the teachings one skilled in the art should appreciate that the scope of the disclosure is intended to cover any aspect of the disclosure disclosed, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As discussed, graph neural networks are a type of artificial neural network that operates on data that is represented as a graph. A graph may include a set of nodes (may also be referred to as “vertices”) and edges. The nodes may represent items or entities while the edges may represent a relationship between the items or entities. A graph neural network takes as input a signal on the graph and outputs a processed signal on the graph. The output signal may be a single vector or a classification for the entire graph. Additionally, nodes in a graph may lack a unique canonical ordering.

Conventional graph convolutional neural networks (graph CNNs) are graph neural networks that consist of multiple convolution layers, interleaved with other layers, such as non-linearities, batch-norm or dropout. One graph convolution layer computes an output signal at node p, only based on the signal at node q if there is an edge between p and q (locality) and use similar neural network weights at different locations in the graph (weight sharing).

A graph neural network Ξ_{G} is equivariant if Ξ_{G}(ϕ(ƒ))=ϕ(Ξ_{G}(ƒ)) or invariant if Ξ_{G}(ϕ(ƒ))=Ξ_{G}(ƒ) for all symmetries ϕ. Conventional graph neural networks (GNNs) achieve equivariance by setting each layer as a message passing layer by an invariant accumulation, such as averaging. Invariant message passing layers are a restricted subset of equivariant layers. Invariant message passing layers may reduce GNN performance because individual layers express less complicated functions. Additionally, after invariant message passing, a source of the message may be lost. This prevents the network from modeling the flow of information through the graph, unlike convolutional neural networks in which information is passed to successive layers of the network. Finally, if applied to planar images, this results in a graph convolutional neural network (CNN) with isotropic convolutions. Isotropic convolutions may be defined as convolutions with kernels that are the same if rotated. These types of graph CNNs are not used in practice because of their limited expressiveness.

Aspects of the present disclosure are directed to constructing and relabeling-equivariant GNN layers. The GNN may be a graph CNN. Specifically, aspects of the present disclosure design general symmetry equivariant graph CNN layers.

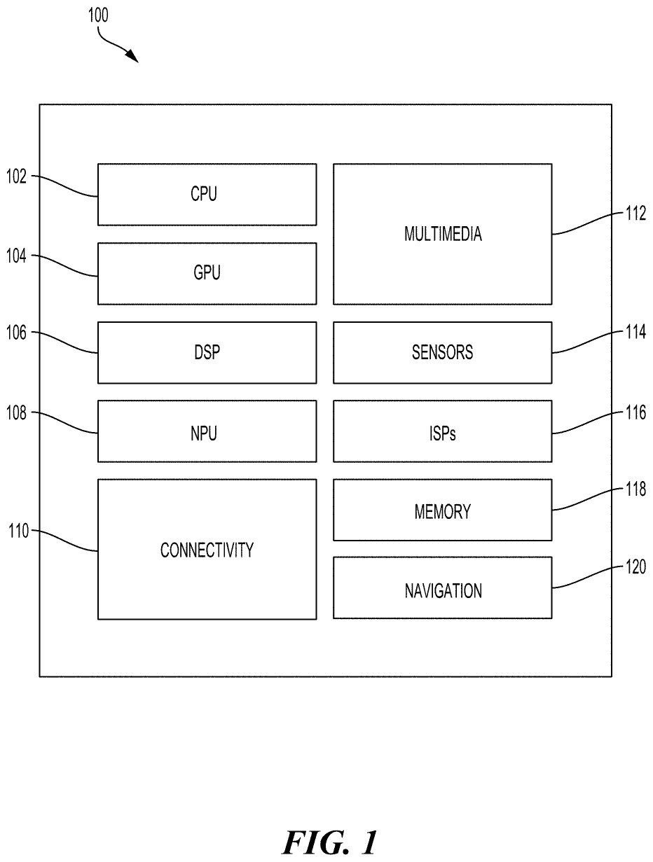

FIG. 1 illustrates an example implementation of a system-on-a-chip (SOC) 100, which may include a central processing unit (CPU) 102 or a multi-core CPU configured for generating a graph convolutional network, in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may comprise code to receive a graph network comprising nodes connected by edges. The instructions may also comprise code to determine a node neighborhood for each of the nodes of the graph network and an edge neighborhood for each of the edges of the graph network. The instructions may further comprise code to classify the node neighborhood for each of the nodes and the edge neighborhood for each of the edges based on isomorphism. The instructions may still further comprise determine a mapping of a kernel from an edge neighborhood class representative to each of the edges of the graph network. The instructions may also comprise code to generating a graph convolutional network based on the mapping.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

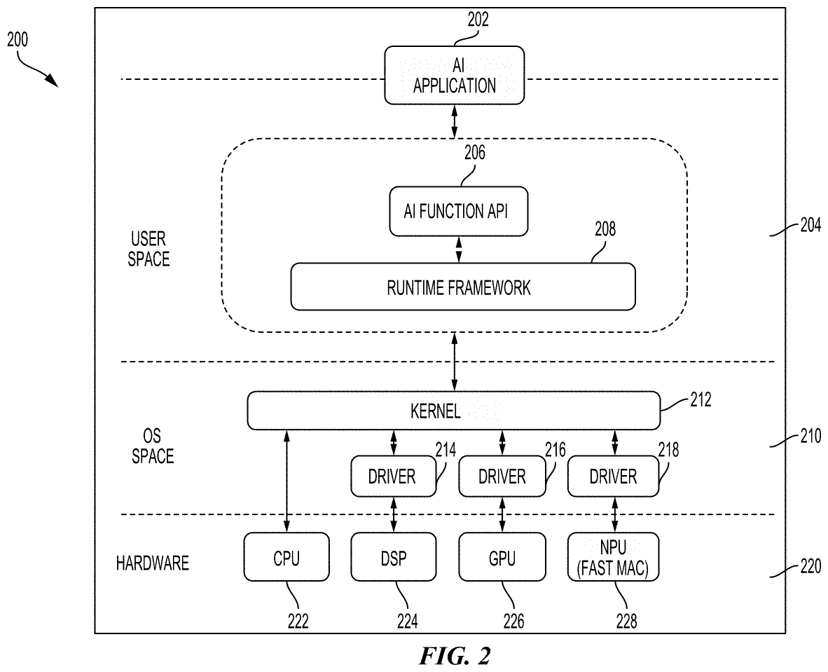

FIG. 2 is a block diagram illustrating an exemplary software architecture 200 that may modularize artificial intelligence (AI) functions. Using the architecture, applications may be designed that may cause various processing blocks of an SOC 220 (for example a CPU 222, a DSP 224, a GPU 226 and/or an NPU 228) to support adaptive rounding as disclosed for post-training quantization for an AI application 202, according to aspects of the present disclosure.

The AI application 202 may be configured to call functions defined in a user space 204 that may, for example, provide for the detection and recognition of a scene indicative of the location in which the device currently operates. The AI application 202 may, for example, configure a microphone and a camera differently depending on whether the recognized scene is an office, a lecture hall, a restaurant, or an outdoor setting such as a lake. The AI application 202 may make a request to compiled program code associated with a library defined in an AI function application programming interface (API) 206. This request may ultimately rely on the output of a deep neural network configured to provide an inference response based on video and positioning data, for example.

A run-time engine 208, which may be compiled code of a runtime framework, may be further accessible to the AI application 202. The AI application 202 may cause the run-time engine, for example, to request an inference at a particular time interval or triggered by an event detected by the user interface of the application. When caused to provide an inference response, the run-time engine may in turn send a signal to an operating system in an operating system (OS) space 210, such as a Kernel 212, running on the SOC 220. In some examples, the Kernel 212 may be a LINUX Kernel. The operating system, in turn, may cause a continuous relaxation of quantization to be performed on the CPU 222, the DSP 224, the GPU 226, the NPU 228, or some combination thereof. The CPU 222 may be accessed directly by the operating system, and other processing blocks may be accessed through a driver, such as a driver 214, 216, or 218 for, respectively, the DSP 224, the GPU 226, or the NPU 228. In the exemplary example, the deep neural network may be configured to run on a combination of processing blocks, such as the CPU 222, the DSP 224, and the GPU 226, or may be run on the NPU 228.

The application 202 (e.g., an AI application) may be configured to call functions defined in a user space 204 that may, for example, provide for the detection and recognition of a scene indicative of the location in which the device currently operates. The application 202 may, for example, configure a microphone and a camera differently depending on whether the recognized scene is an office, a lecture hall, a restaurant, or an outdoor setting such as a lake. The application 202 may make a request to compiled program code associated with a library defined in a SceneDetect application programming interface (API) 206 to provide an estimate of the current scene. This request may ultimately rely on the output of a differential neural network configured to provide scene estimates based on video and positioning data, for example.

A run-time engine 208, which may be compiled code of a Runtime Framework, may be further accessible to the application 202. The application 202 may cause the run-time engine, for example, to request a scene estimate at a particular time interval or triggered by an event detected by the user interface of the application. When caused to estimate the scene, the run-time engine may in turn send a signal to an operating system 210, such as a Linux Kernel 212, running on the SOC 220. The operating system 210, in turn, may cause a computation to be performed on the CPU 222, the DSP 224, the GPU 226, the NPU 228, or some combination thereof. The CPU 222 may be accessed directly by the operating system, and other processing blocks may be accessed through a driver, such as a driver 214-218 for a DSP 224, for a GPU 226, or for an NPU 228. In the exemplary example, the differential neural network may be configured to run on a combination of processing blocks, such as a CPU 222 and a GPU 226, or may be run on an NPU 228.

Convolutional neural networks (CNNs) may be considered the backbone of machine learning. In some cases, CNNs process images, which may be considered as signals on a plane. However, some machine learning domains process graph signals (e.g., data defined on a graph). Examples of data defined on a graph include social networks, reference/citation networks, data in an unstructured database, knowledge graphs, and search trees.

Furthermore, data represented in other structures may also be represented on a graph. Still, some structural information may be lost in the graph representation. Examples of such data are computer program code, planar images, discrete manifolds (meshes), and molecular structures. Methods for signal processing on graphs are thus widely applicable.

A graph G=(V,E) is a finite collection of nodes/vertices V and a set of edges E. An edge may be defined as a pair of nodes that are connected. A signal on a graph may be a vector of information attached to each node of the graph. Assuming a D-dimensional signal at each node, a signal can be written as a tuple of vectors (ƒₚ)_{peV}, ƒₚ∈ [symbol] ^{D}, where p is a node, or as a function ƒ:V→ [symbol] ^{D}.

A graph neural network (GNN) is a neural network that receives a signal on the graph and outputs a processed signal on the graph. The output signal may be a single vector (e.g., classification) for the whole graph. A processed signal may be defined as Ξ_{G} (ƒ):V→ [symbol] ^{D}.

A graph convolutional neural network (graph CNN) is a graph neural network with multiple convolution layers interleaved with other layers, such as non-linearities, batch-norm, and/or dropout. A graph convolution layer computes an output signal at node p, based on the signal at node q if there is an edge between p and q (e.g., locality). The graph convolution layer uses similar neural network weights at different locations in the graph (e.g., weight sharing).

A graph morphism between graphs G, G′, is a map between the vertices ϕ:V(G)→V(G′), such that if (p,q)∈E(G), then (ϕ(p),ϕ(q))∈E(G′). Graph isomorphism refers to a graph morphism with bijection. That is, graph isomorphism is a mapping from one graph to another that can be reversed by an inverse mapping. Graph automorphism refers to shuffling nodes of a graph, such that a set of edges remains invariant. Specifically, graph automorphism is a bijective map ϕ: V→V, such that (p,q)∈E⇔(ϕ(p),ϕ(q))∈E, where the symbol ⇔ means if and only if. Graph automorphism may also be referred to as a symmetry of the graph. Graph automorphism transforms a scalar signal on the graph as ϕ(ƒ): V→ [symbol] ^{D}, ϕ(ƒ)(p)=ƒ(ϕ⁻¹(p)). A GNN (Ξ_{G}) is equivariant if Ξ_{G}(ϕ(ƒ))=ϕ(Ξ_{G}(ƒ)) or invariant if Ξ_{G}(ϕ(ƒ))=ξ_{G}(ƒ) for all symmetries ϕ.

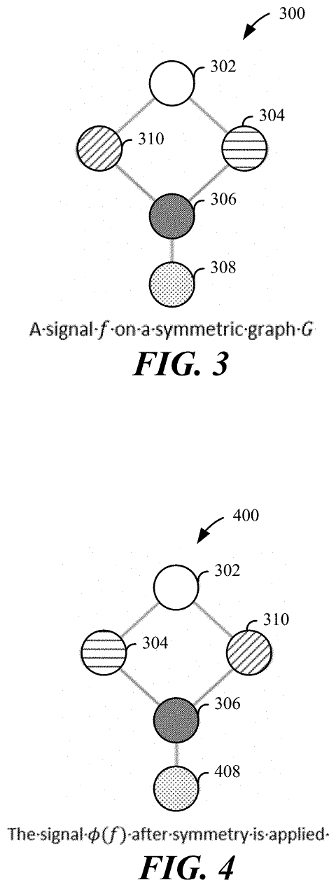

FIGS. 3 and 4 are diagrams respectively illustrating example graphs 300 and 400, in accordance with aspects of the present disclosure. When a graph has symmetries, the nodes may not be canonically ordered and may not be uniquely labeled. In the example of FIG. 3, a signal ƒ can be canonically disambiguated (e.g., identified) from the signal ϕ(ƒ) at FIG. 4 after applying symmetry. That is, graphs are not naturally labeled. The structure of the graph 300 of FIG. 3 is the same as the structure of the graph 400 of FIG. 4. Nodes 302, 304, 306, 308, 310 may be arbitrarily indexed. In FIGS. 3 and 4, each node 302, 304, 306, 308, 310 may be associated with a different signal (e.g., a different vector). The pattern of each node 302, 304, 306, 308, 310 in FIGS. 3 and 4 corresponds to a signal. Because the graphs 300, 400 have the same structure, both graphs 300, 400 encode the same information regardless of the node indexing.

Conventional GNN models may achieve equivariance by setting each layer as an invariant message passing layer. Between message passing, a linear transformation by a matrix W and/or non-linearity r may be applied to the features at the nodes p, as follows:

$${{Ξ}_{G} ( f )}_{p} = r ( {\sum }_{( p , q ) ∈ E} W {f}_{q} ) . \qquad ( 1 )$$

Equation 1 determines a convolution (Ξ) for a graph G of a signal fat node p. In equation 1, data may be transformed with a matrix-vector product. The signals from all neighbors q of node p are summed. The edges from nodes q to node p are a subset of all edges E in a graph G.

Invariant message passing layers are a restricted subset of all possible equivariant layers. Conventional GNNs reduce network performance because the individual layers express less complicated functions. Additionally, after message passing, a source of the message may not be retained. This may prevent the conventional networks from modeling the flow of information through the graph. If applied to planar images, the conventional GNN model results in a CNN with isotropic convolutions (e.g., same magnitude in all directions), which are not used in practice because of limited expressiveness. As discussed, isotropic convolutions may be defined as convolutions with kernels that are the same if rotated.

Aspects of the present disclosure provide a general method for constructing and relabeling equivariant graph CNN layers. That is, aspects of the present disclosure are directed to equivariant message passing. The equivariant message passing is distinguishable from the invariant message passing of conventional GNNs.

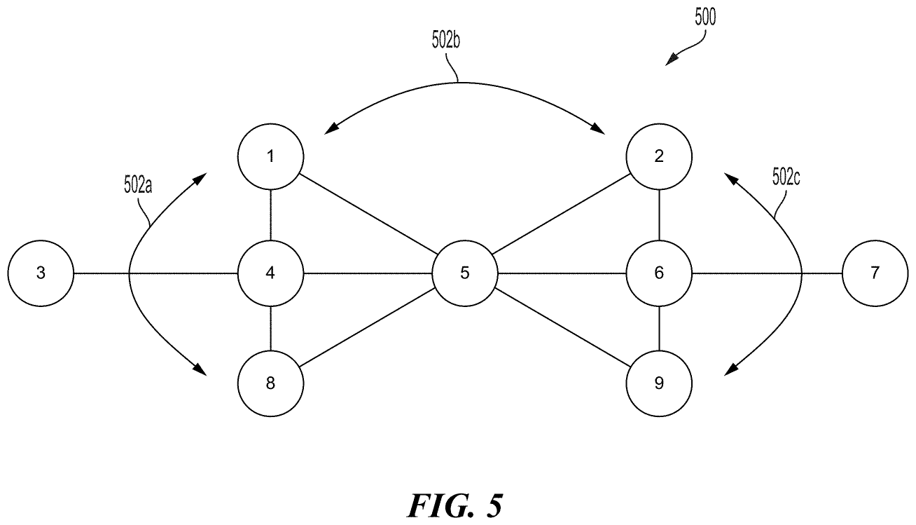

FIG. 5 is an example symmetric graph 500, according to aspects of the present disclosure. A convolution of the symmetric graph 500 will receive an input signal and output a signal (e.g., a feature vector) at each node (e.g., nodes 1-9). For example, the output feature at a node 5 in the graph 500 will be a linear combination of the input features at the neighboring nodes (e.g., the nodes in each of arcs 502a, 502b, and 502c, respectively) of node 5.

Aspects of the present disclosure are directed to defining a convolution in a GNN. According to aspects of the present disclosure, at a first step, a convolution may be defined by finding node and edge neighborhoods in the graph. The node and edge neighborhoods may be classified into isomorphism classes. For each node neighborhood class and edge neighborhood class, one neighborhood may be selected as the representative of the node/edge class. For each node class, nodes of the representative neighborhood are arbitrarily labeled. A mapping of the representative neighborhood to all neighborhoods in the class may be determined. Then, for each edge neighborhood class representative, a kernel constraint may be determined. In turn, the kernel may be transported from the edge class representatives to each edge and the convolution may be computed.

In some aspects, the steps of determining node and edge neighborhoods, selecting a representative, and mapping the representative to each neighborhood in the class may be pre-computed. Additionally, in some aspects, the steps of transporting the kernel and computing the convolution may be executed during training of the network and/or inference.

As discussed above, a first step includes finding the node and edge neighborhoods in the graph. For each node p, a sub-graph may be determined, which includes p, as the neighborhood. Similarly, a neighborhood for each edge may be determined, containing the edge.

A closed node neighborhood for a given node p includes each node at a distance up to k from node p, and each edge between the selected nodes, where k is n integer that is greater than zero. An open node neighborhood for node p includes each edge (q, q′) if either q or q′ may be at a distance up to k−1 from node p, and each node at the selected edges (k-open selection).

A closed edge neighborhood of an edge (p, p′) includes each node at a distance up to k from node p or p′, and each edge between the selected nodes. For example, given an edge (4, 5) where p=4 and p′=5, the closed neighborhood of this edge includes all nodes except for node 7 and all edges between these nodes (so excluding only the edge (6, 7)). This is because all nodes except for node 7 are at most 1 removed from either node 4 or node 5. An open edge neighborhood includes each edge (q, q′) if either q or q′ may be at a distance up to k−1 from node p or p′, and each node at the selected edges. For instance, the 1-closed neighborhood of edge (4, 5), all edges (q, q′) in which either q or q′ are 1−1=0 removed from either 4 or 5 may be selected, so we select edges that have one end be edge 4 or 5. Accordingly, the closed neighborhood also has all nodes except node 7, but now has all edges except for edges (6,7), (2, 6) and (6, 9).

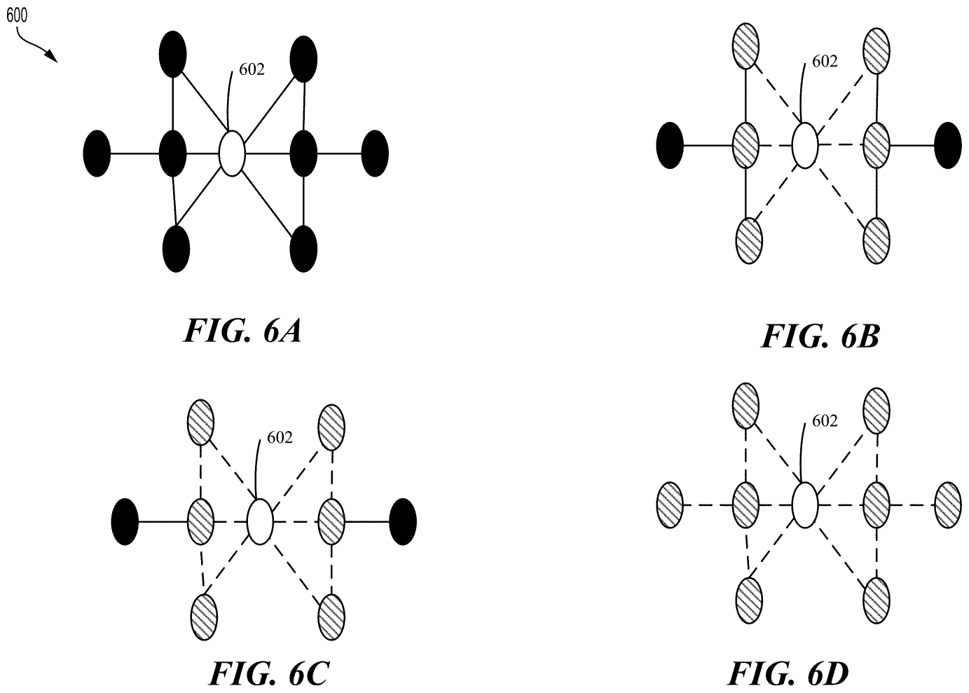

FIG. 6A illustrates an example of a graph 600 for a first node p 602. FIG. 6B illustrates an example of the open node neighborhood, where k equals one. FIG. 6C illustrates an example of the closed of node neighborhood, where k equals one. FIG. 6D illustrates an example of the closed and open types of node neighborhoods where k equals two. In FIGS. 6B-6D, the nodes in the neighborhood are designated with patterns and the edges in the neighborhood are designated with dashes. Aspects of the disclosure will use the first type of node neighborhood as an example.

As previously discussed, a second step includes classifying the node and edge neighborhoods into isomorphism classes. It is noted that some node neighborhoods are isomorphic. That is, multiple nodes may have the same neighborhood layout (e.g., isomorphic neighborhoods). More specifically, isomorphism exists between node neighborhoods that may be mapped node to node. Edge neighborhoods may also be isomorphic.

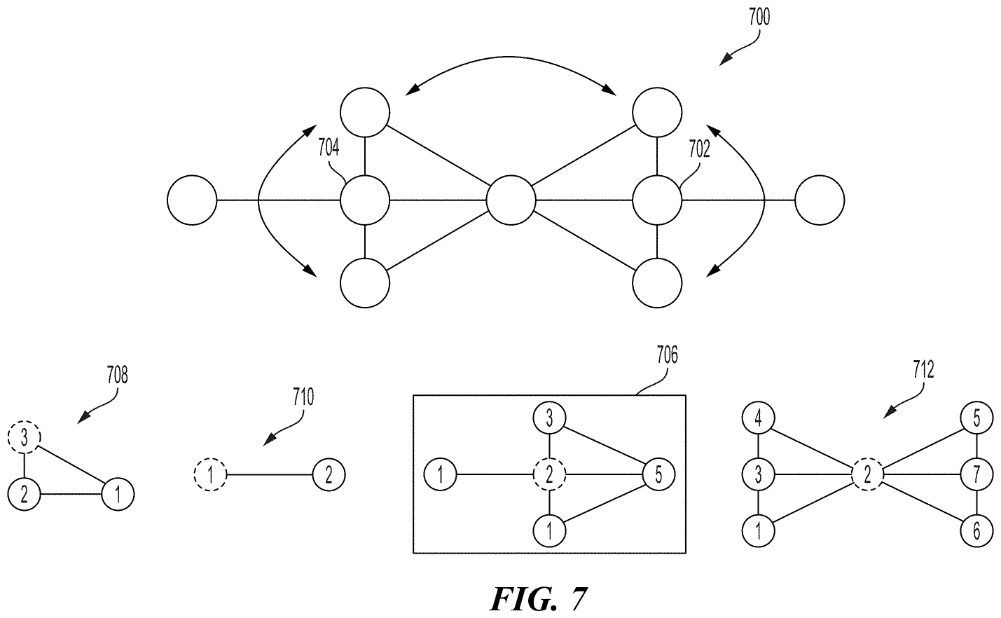

FIG. 7 illustrates an example of isomorphic node classes 706, 708, 710, 712 based on a graph 700, in accordance with aspects of the present disclosure. In the example of FIG. 7, a third node class 706 may be mapped to either a first node 704 or a second node 702. That is, a neighborhood of the first node 704 has a same layout as a neighborhood of the second node 702.

The nodes in each node class 706, 708, 710, 712 may be arbitrarily labeled. When a representative node is selected in a graph, the nodes in the neighborhood of the representative node may be labeled according to the arbitrary labeling of the classes 706, 708, 710, 712.

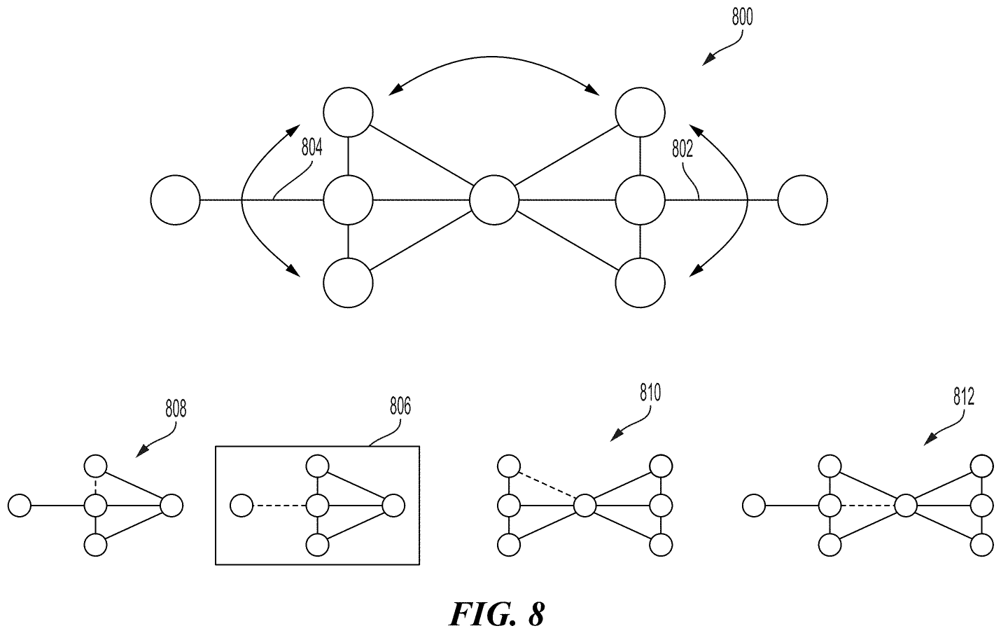

FIG. 8 illustrates an example of isomorphic edge classes 806, 808, 810, 812 based on a graph 800, in accordance with aspects of the present disclosure. In the example of FIG. 8, a second edge class 806 may be mapped to either a first edge 804 or a second edge 802. That is, a neighborhood of the first edge 804 has a same layout as a neighborhood of the second edge 802. Accordingly, using the node classes of FIG. 7 and the edge classes of FIG. 8, local symmetries may be determined for the graph (e.g., graph 800).

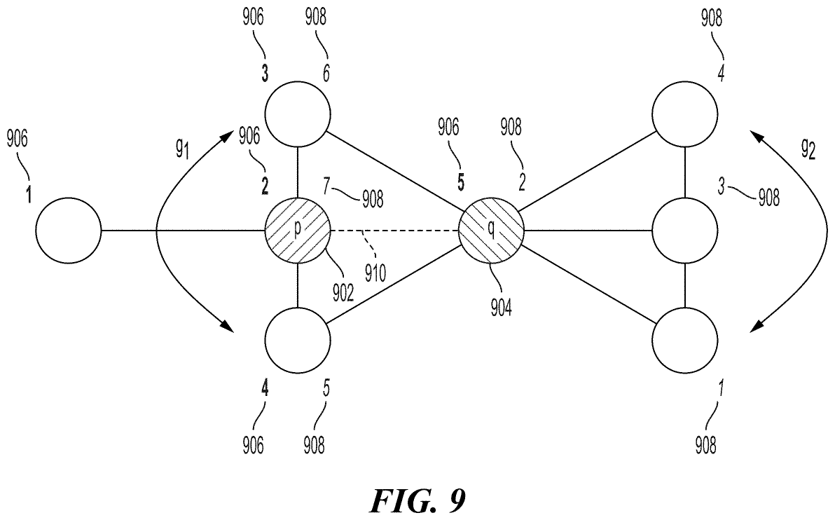

FIG. 9 illustrates an example of a labeling 906, 908 of a neighborhood of two nodes 902, 904, in accordance with aspects of the present disclosure. In FIG. 9, a first node p 902 corresponds to a third class 706, as shown in FIG. 7. The nodes in the neighborhood of the first node p 902 are labeled 906 according to the labels of the third class 706. In FIG. 9, a second node q 904 corresponds to a fourth class 712, as shown in FIG. 7. The nodes in the neighborhood of the second node q 904 are labeled 908 according to the labels of the fourth class 712. The labeling 906, 908 may not be a one-to-one mapping to the classes 706, 708, 710, 712 of FIG. 7 as labels for isomorphic nodes may be swapped.

As discussed above, at a third step for defining the convolution, the kernel constraint may be solved. At node p, Nₚ is the number of nodes in the node neighborhood of p. The feature at node p, ƒₚ is a Nₚ-dimensional vector. The kernel that passes a message from node p to node q, K_{pq} is thus a Nₐ×Nₚ dimensional matrix. If the kernel satisfies a linear constraint, then symmetry equivariance may be achieved. This constraint may be solved for each edge class representative.

FIG. 9 illustrates an edge 910 connecting the first node p 902 to the second node q 904. The neighborhood of the first node p 902 includes five nodes and the neighborhood of the second node q 904 includes seven nodes. For a neighborhood of the edge 910, a kernel may be mapped from the vector ƒₚ to a new feature vector ƒ_{q}′. The kernel K_{pq} may, for example, be a 7×5 dimensional matrix. It is noted that this neighborhood has two symmetries itself, labeled g₁,g₂. Here, only symmetries that leave the edge invariant are considered. The matrix ρₚ(g₁) may be a 5×5 matrix switching the third and fourth dimension (e.g., labeled 906 nodes three and four), the matrix ρ_{q} (g₁) may be a 7×7 matrix switching the fifth and sixth dimensions (e.g., labeled 908 nodes five and six), and the matrix ρ_{q} (g₂) may be the 7×7 matrix switching the first and fourth dimension (labeled 908 nodes one and four).

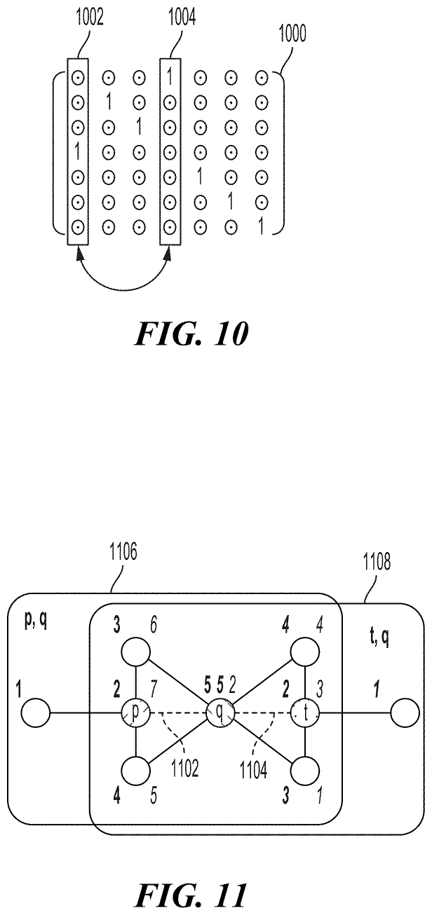

FIG. 10 illustrates an example of a matrix 1000 for switching symmetries, in accordance with aspects of the present disclosure. The matrix 1000 of FIG. 10 corresponds to the aforementioned 7×7 matrix switching the first and fourth dimension (e.g., ρ_{q} (g₂)). As shown in FIG. 10, values of a first row 1002 have been switched with values of a fourth row 1004.

In the current example, the kernel matrix K_{pq} satisfies both:

K_{pq}ρₚ(g₁)=ρ_{q}(g₁)K_{pq} (2)

K_{pq}=ρ_{q}(g₂)K_{pq} (3)

A basis of an independent solution may be referred to as basis kernels K_{pq}^{b}, which can be linearly combined to construct any kernel satisfying these constraints. In general, the edge neighborhood of edge (p,q) 910, as shown in FIG. 9, has a group of symmetries H_{pq}. Just as in the above example, for group element g∈H_{pq}, ρₚ(g) permutes the node neighborhood of node p according to the symmetry of the edge neighborhood. The matrix ρ_{q} (g) is similar for the node neighborhood of node q. Then, ∀g∈H_{pq}, ρ_{q}(g)K_{pq}=K_{pq}ρₚ(g) may be used.

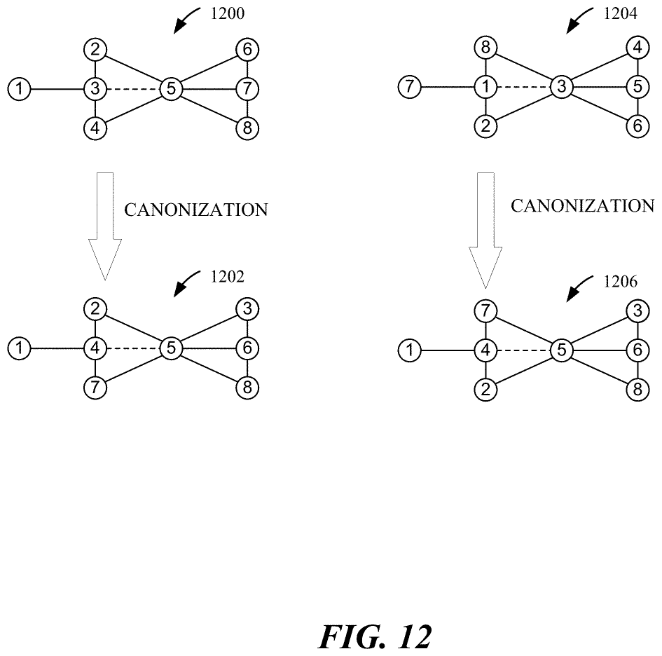

As discussed above, for a fourth step of defining the convolution, the kernel may be transported. To achieve equivariance, the kernel constraint is satisfied and the kernel is shared between isomorphic edge neighborhoods. FIG. 11 illustrates an example of transporting a kernel, in accordance with aspects of the present disclosure. In FIG. 11, an edge (p,q) 1102 and an edge (t,q) 1104 have isomorphic neighborhoods. The edge (p,q) 1102 may be the representative of the class, thus K_{tq} may be inferred from K_{pq}. To infer K_{tq} from K_{pq}, a mapping may be found from an edge neighborhood 1108 of (t,q) to an edge neighborhood 1106 of (p,q).

As shown in FIG. 11, the mapping may be a horizontal mirroring. In general, after mapping the edge neighborhoods, the labels may not align. The permutation g_{p→t} corrects the misalignment. In FIG. 11, g_{p→t} represents the swap of the third and fourth nodes, as mirroring. Applying this swap aligns the neighborhoods of p and t. Similarly, g_{q→q} is a swap of the q neighborhood, which swaps the fourth and sixth nodes, the seventh and third nodes, and the fifth and first nodes of the neighborhoods for node q. The kernel K_{pq} to (t,q) may be transported by:

K_{tq}=ρ_{q}(g_{q→q}⁻¹)K_{pq}ρₜ(g_{p→t}) (4)

As discussed with reference to a fifth step, the convolution may be computed. For each edge class representative (p,q), a set of basis kernels K_{pq}^{b} and set of parameters θ_{pq}^{b} may be defined. The set of basis kernels K_{pq}^{b} and set of parameters θ_{pq}^{b} may be combined to form the kernel K_{pq}=_{b} K_{pq}^{b}θ_{pq}^{b}. The kernel K_{pq} may, in turn, be transported to the other edges in the edge class, which yields a kernel at each edge. The convolution may thus be defined as:

$${{Ξ}_{G} ( f )}_{p} = {\sum }_{( p , q ) ∈ E} {K}_{pq} {f}_{q} . \qquad ( 5 )$$

As discussed, if edges are isomorphic, then the edges may share kernels. However, if edges are non-isomorphic then kernels may not be shared. In some aspects, kernels may also be shared between non-isomorphic edges. These kernels may be shared via kernel canonization.

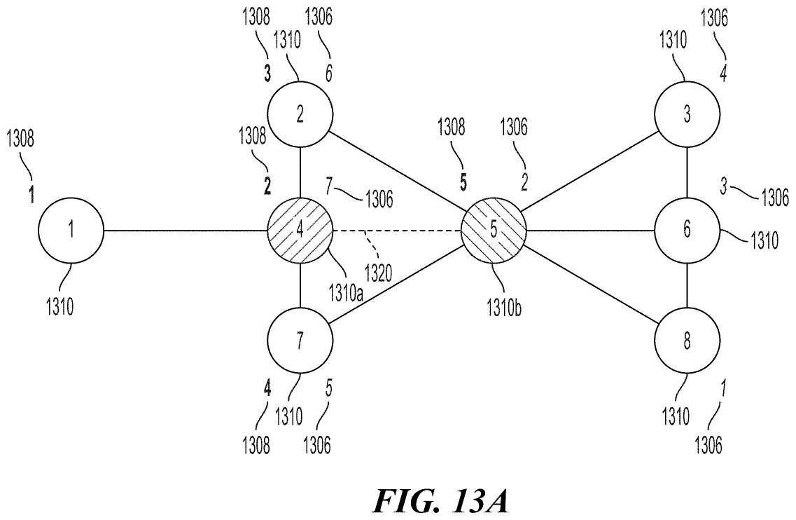

A graph canonization function may be considered a function to find a unique labeling of nodes of a graph, up to symmetry. FIG. 12 illustrates examples of graph canonization, according to aspects of the present disclosure. As shown in FIG. 12, two isomorphic neighborhoods 1200, 1202 with a different ordering of vertices are canonized. Isomorphic graphs 1204, 1206 are labeled the same such that the set of edges remains invariant.

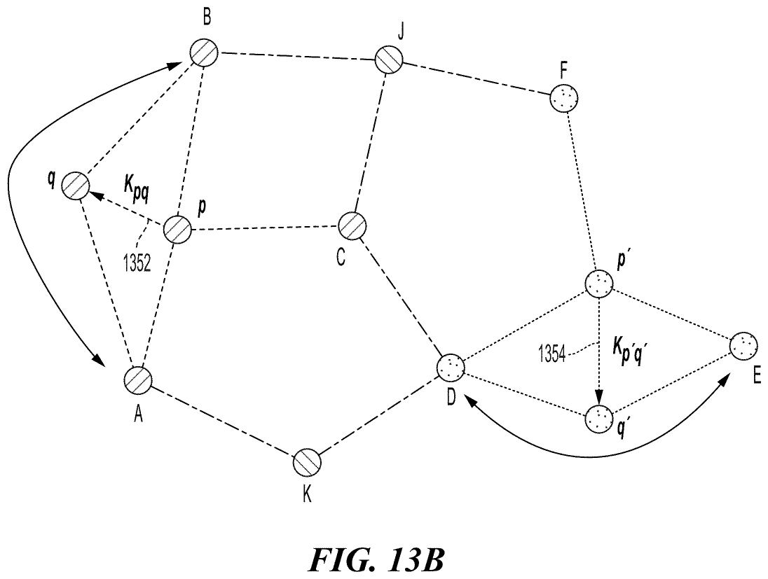

FIG. 13A illustrates an example of graph canonization, according to aspects of the present disclosure. As shown in FIG. 13A, a kernel K_{pq} may be defined for an edge 1320 from a first node p 1310a to a second node q 1310b. For example, in FIG. 13A, the kernel K_{pq} may be a 7×5 matrix. Each column of this matrix corresponds to a node 1308 in the input neighborhood (e.g., corresponding to the first node 1310a). Each row corresponds to a node 1306 in the output neighborhood (e.g., corresponding to the second node 1310b). The labeling of the nodes 1306, 1308 may be arbitrary. Canonical labeling (including labels for nodes 1310a and 1310b) may be unique (up to a symmetry). Therefore, a canonical index 2 may be uniquely assigned to the third column. That is, a third node 1308 in the input neighborhood has the canonical label 2 (e.g., node 1310 with label 2). Similarly, a canonical index 8 may be assigned to the first row. That is, the first node 1306 in the output neighborhood has canonical index 8 (e.g., node 1310 with label 8). For example, (K_{pq})_{1,3} has row and column labels (8, 2). These labels allow for sharing weights between inequivalent edges.

If the largest edge neighborhood has M nodes, kernels of all edges are derived from a single M×M parameter matrix θ. Based on FIG. 13A, ( [symbol] )_{1,3}=θ_{8,2.}. In general, Cₚ^{pq}(i) is the canonical label of the ith node of the p neighborhood. Thus, the elements of the matrix [symbol] are:

( [symbol] )ᵢⱼ=θ_{C}_{_{q}}_{^{pq}}_{(i),C}_{_{q}}_{^{pq}}₍ⱼ₎ (6)

The matrix [symbol] does not yet satisfy the equivariance equation for edge pq. Thus, a kernel K_{pq} may be defined as the matrix closest to [symbol] that satisfies the kernel constraint. This can be computed from the basis kernels K_{pq}^{b} as:

$${( {K}_{pq} )}_{ij} = {\sum }_{b , k , l} {( )}_{kl} {( {K}_{pq}^{b} )}_{kl} {( {K}_{pq}^{b} )}_{ij} \qquad ( 7 )$$

One alternative strategy for sharing weight between non-isomorphic edges may be described as follows. For simplicity of exposition, assume that all edge kernels have the same shape and same number of basis kernels. This may be accomplished by padding the kernels with zeroes.

The kernel matrix may be expressed as linear combinations of basis kernels K_{pq}^{b} by parameters θ_{pq}^{b}:(K_{pq})ᵢⱼ=Σ_{b}θ_{pq}^{b}K_{pq,ij}^{b}. The convolution is, now including the indices of the kernel matrix:

$${{Ξ}_{G} ( f )}_{p , i} = {\sum }_{( p , q ) ∈ E , j} {K}_{pq , ij} {f}_{q , j} = {\sum }_{( p , q ) ∈ E , b , j} {θ}_{pq}^{b} {K}_{pq , ij}^{b} {f}_{q , j} . \qquad ( 8 )$$

Here, p indexes the output node, q indexes the input node, b indexes the basis kernels, i and j index the dimensions of the output and input vectors as well as the kernel matrix.

Equivariant neural networks may use multiple copies of the equivariant kernels, resulting in a general equivariant convolution expressed as:

$${{Ξ}_{G} ( f )}_{p , m , i} = {\sum }_{( p , q ) ∈ E , n , j} {K}_{pq , mn , ij} {f}_{q , n , j} = {\sum }_{( p , q ) ∈ E , n , b , j} {θ}_{pq , mn}^{b} {K}_{pq , ij}^{b} {f}_{q , n , j} . \qquad ( 9 )$$

The general equivariant convolution includes many parameters θ per edge. The number of parameters may be reduced by letting θ_{pq,mn}^{b} be the result of a contraction:

$${θ}_{pq , mn}^{b} = {\sum }_{c} {κ}_{p , q}^{b , c} {η}_{mn}^{c} . \qquad ( 10 )$$

A number of values received by index c may be smaller than a number of copies m and n. This results in many fewer parameters and hence improved learning. This strategy of constructing a tensor with a large number of indices out of multiple smaller tensors may be a common strategy in many fields, including machine learning and quantum computation.

FIG. 13B is a diagram illustrating a graph, in accordance with aspects of the present disclosure. Referring to FIG. 13B, a node p and a node q are shown. An edge 1352 is defined between node p and node q for passing information between node p and node q using a linear matrix Kpq (the convolutional kernel from node p to node q). For example, the neighborhood for edge 1352 may include all of the nodes within one hop from the beginning of edge 1352 (e.g., node p) or ending of edge 1352 (e.g., node q). The neighborhood of edge 1352 may include the edges that connect node p or node q to nodes A, B, and C. Similarly, an edge 1354 defined between node p′ and node q′ has a neighborhood that includes the edges the connect node p or node q′ to nodes D, E, and F.

Additionally, node neighborhoods for node p and q may be identified. The node neighborhood may, for example, include the nodes that share an edge. In the example of FIG. 13B, the node neighborhood for node q may include nodes A, B, p and q. The node neighborhood for node p may include nodes A, B, C and p. Likewise a node neighborhood for node q′ may be identified as including nodes D, E, p′ and q′. The node neighborhood for node p′ may be identified as including nodes D, E, F, p′ and q′. However, the node neighborhood for node p′ may not include nodes J, K, p or A, for example.

The edge and node neighborhood for the graph shown in FIG. 13B may be classified according to isomorphism. In this example, an isomorphism may be determined between the graph q and the graph q′. An isomorphism may also be determined between a graph p and a graph p′. On the other hand, an isomorphism may not be determined between a graph B and a graph F. Similarly, an isomorphism may not be determined between a graph p and a graph E.

Having classified the edge and node neighborhoods, a kernel constraint may be determined. If edges (e.g., 1352, 1354) have isomorphic neighborhoods, then weights may be shared. For instance, the convolutional kernel Kp′q′ may be fully determined by the weight matrix of Kpq. Additionally, if an edge neighborhood has symmetry, a linear constraint may be determined such that the weights between the corresponding edge kernels may be shared. As such, the weights between the edge neighborhood for edge 1352 may be shared with the weights for the edge neighborhood for edge 1354.

Aspects of the present disclosure have advantages over conventional methods. For example, aspects of the present disclosure improve expressiveness, allowing for more powerful graph neural networks. When applied to planar images, the method results in a conventional equivariant planar CNN. As the convolution may be more expressive, additional methods that increase the expressiveness of graph CNNs, such as attention, may no longer be necessary. By different selection of the neighborhood sizes, a trade-off can be made between weight sharing and expressiveness. This allows the user to trade-off learning efficiency with maximum discriminative power. If kernel canonization is used, weight sharing is as efficient as in conventional graph CNNs, but the networks may be more expressive.

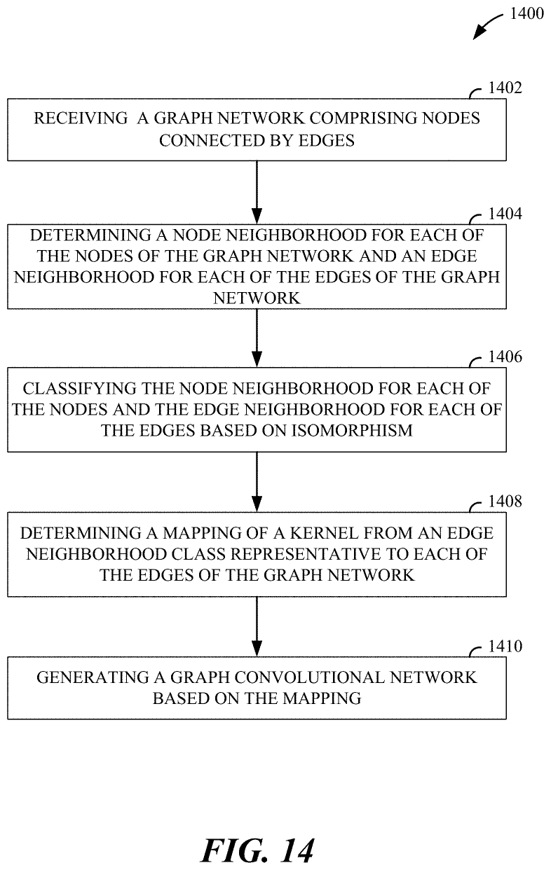

FIG. 14 illustrates a flow diagram for a method 1400, according to an aspect of the present disclosure. As shown in FIG. 14, at block 1402, a graph network comprising nodes connected by edges is received. For example, with reference to FIG. 5, a graph network is shown with multiple nodes (e.g., 1-9) that are connected by edges.

At block 1404, the method 1400 determines a node neighborhood for each of the nodes of the graph network and an edge neighborhood for each of the edges of the graph network. As discussed with reference to FIG. 5, for each node p, a sub-graph may be selected, which includes p, as the neighborhood. Similarly, a neighborhood for each edge may be determined, containing the edge. In some aspects, the edge neighborhoods and the node neighborhoods may be respectively determined based on a closed node neighborhood approach or an open neighborhood approach.

At block 1406, the method 1400 classifies the node neighborhood for each of the nodes and the edge neighborhood for each of the edges based on isomorphism. For example, as shown in FIG. 9, a first node p 902 corresponds to a third class 706 (shown in FIG. 7), while a second node q 904 corresponds to a fourth class 712 (shown in FIG. 7).

At block 1408, the method 1400 determining a mapping of a kernel from an edge neighborhood class representative to each of the edges of the graph network. As discussed with reference to FIG. 9, a linear constraint may be determined such that symmetry equivariance may be achieved. This constraint may be solved for each edge class representative. The kernel may be transported from each edge class representative to each edge. In some aspects, a mapping of the representative neighborhood to all neighborhoods in the class may be determined.

Finally, at block 1410, the method 1400 generates a graph convolutional network based on the mapping. As discussed, a convolution may be computed based on the kernel mapping.

In one aspect, the receiving means, determining means, classifying means, means for determining a mapping, and/or generating means may be the CPU 102, program memory associated with the CPU 102, DSP 106, CPU 222, and or NPU 228 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

Implementation examples are described in the following numbered clauses.

1. A method, comprising:

receiving a graph network comprising nodes connected by edges;

determining a node neighborhood for each of the nodes of the graph network and an edge neighborhood for each of the edges of the graph network;

classifying the node neighborhood for each of the nodes and the edge neighborhood for each of the edges based on isomorphism;

determining a mapping of a kernel from an edge neighborhood class representative to each of the edges of the graph network; and

generating a graph convolutional network based on the mapping.

2. The method of clause 1, further comprising:

selecting the edge neighborhood class representative for isomorphic edge neighborhoods of the graph network; and

selecting a node class representative for isomorphic node neighborhoods of the graph network.

3. The method of any of clauses 1-2, further comprising:

arbitrarily labeling each node of the node class representative; and

identifying a second mapping of the node class representative to all neighborhoods in the node neighborhood class of the node class representative.

4. The method of any of clauses 1-3, in which the mapping is determined by applying a kernel constraint for the edge neighborhood class representative.
5. The method of any of clauses 1-4, in which node neighborhoods, edge neighborhoods, the node neighborhood class, the edge neighborhood class, and the kernel constraint for the edge neighborhood class representative are pre-determined based on a symmetry of a corresponding edge neighborhood.
6. The method of any of clauses 1-5, further comprising receiving an input via the graph convolutional network and computing a convolution based on the mapping.
7. The method of any of clauses 1-6, further comprising sharing the kernel between non-isomorphic edges via kernel canonization.
8. The method of any of clauses 1-6, further comprising sharing the kernel between non-isomorphic edges via tensor factorization.
9. An apparatus, comprising:

a processor,

memory coupled with the processor; and

instructions stored in the memory and operable, when executed by the processor, to cause the apparatus:

to receive a graph network comprising nodes connected by edges;

to determine a node neighborhood for each of the nodes of the graph network and an edge neighborhood for each of the edges of the graph network;

to classify the node neighborhood for each of the nodes and the edge neighborhood for each of the edges based on isomorphism;

to determine a mapping of a kernel from an edge neighborhood class representative to each of the edges of the graph network; and

to generate a graph convolutional network based on the mapping.

10. The apparatus of clause 9, in which the instructions further cause the apparatus:

to select the edge neighborhood class representative for isomorphic edge neighborhoods of the graph network; and

to select a node class representative for isomorphic node neighborhoods of the graph network.

11. The apparatus of any of clauses 9-10, in which the instructions further cause the apparatus:

to arbitrarily label each node of the node class representative; and

to identify a second mapping of the node class representative to all neighborhoods in the node neighborhood class of the node class representative.

12. The apparatus of any of clauses 9-11, in which the instructions further cause the apparatus to determine the mapping by applying a kernel constraint for the edge neighborhood class representative.
13. The apparatus of any of clauses 9-12, in which node neighborhoods, edge neighborhoods, the node neighborhood class, the edge neighborhood class, and the kernel constraint for the edge neighborhood class representative are pre-determined based on a symmetry of a corresponding edge neighborhood.
14. The apparatus of any of clauses 9-13, in which the instructions further cause the apparatus:

to receive an input via the graph convolutional network; and

to compute a convolution based on the mapping.

15. The apparatus of any of clauses 9-14, in which the instructions further cause the apparatus to share the kernel between non-isomorphic edges via kernel canonization.
16. The apparatus of any of clauses 9-14, in which the instructions further cause the apparatus to share the kernel between non-isomorphic edges via tensor factorization.
17. An apparatus, comprising:

means for receiving a graph network comprising nodes connected by edges;

means for determining a node neighborhood for each of the nodes of the graph network and an edge neighborhood for each of the edges of the graph network;

means for classifying the node neighborhood for each of the nodes and the edge neighborhood for each of the edges based on isomorphism;

means for determining a mapping of a kernel from an edge neighborhood class representative to each of the edges of the graph network; and

means for generating a graph convolutional network based on the mapping.

18. The apparatus of clause 17, further comprising:

means for selecting the edge neighborhood class representative for isomorphic edge neighborhoods of the graph network; and

means for selecting a node class representative for isomorphic node neighborhoods of the graph network.

19. The apparatus of any of clauses 17-18, further comprising:

means for arbitrarily labeling each node of the node class representative; and

means for identifying a second mapping of the node class representative to all neighborhoods in the node neighborhood class of the node class representative.

20. The apparatus of any of clauses 17-19, further comprising means for applying a kernel constraint for the edge neighborhood class representative.
21. The apparatus of clause any of clauses 17-20, in which node neighborhoods, edge neighborhoods, the node neighborhood class, the edge neighborhood class, and the kernel constraint for the edge neighborhood class representative are pre-determined based on a symmetry of a corresponding edge neighborhood.
22. The apparatus of any of clauses 17-21, further comprising:

means for receiving an input via the graph convolutional network; and

means for computing a convolution based on the mapping.

23. The apparatus of any of clauses 17-22, further comprising means for sharing the kernel between non-isomorphic edges via kernel canonization.
24. The apparatus of any of clauses 17-22, further comprising means for sharing the kernel between non-isomorphic edges via tensor factorization.
25. A non-transitory computer-readable medium having program code recorded thereon, the program code being executed by an apparatus and comprising:

program code to receive a graph network comprising nodes connected by edges;

program code to determine a node neighborhood for each of the nodes of the graph network and an edge neighborhood for each of the edges of the graph network;

program code to classify the node neighborhood for each of the nodes and the edge neighborhood for each of the edges based on isomorphism;

program code to determine a mapping of a kernel from an edge neighborhood class representative to each of the edges of the graph network; and

program code to generate a graph convolutional network based on the mapping.

26. The non-transitory computer-readable medium of clause 25, further comprising:

program code to select the edge neighborhood class representative for isomorphic edge neighborhoods of the graph network; and

program code to select a node class representative for isomorphic node neighborhoods of the graph network.

27. The non-transitory computer-readable medium of any of clauses 25-26, further comprising:

program code to arbitrarily label each node of the node class representative; and

program code to identify a second mapping of the node class representative to all neighborhoods in the node neighborhood class of the node class representative.

28. The non-transitory computer-readable medium of any of clauses 25-27, further comprising program code to determine the mapping by applying a kernel constraint for the edge neighborhood class representative.
29. The non-transitory computer-readable medium of any of clauses 25-28, in which node neighborhoods, edge neighborhoods, the node neighborhood class, the edge neighborhood class, and the kernel constraint for the edge neighborhood class representative are pre-determined based on a symmetry of a corresponding edge neighborhood.
30. The non-transitory computer-readable medium of any of clauses 25-29, further comprising:

program code to receive an input via the graph convolutional network; and program code to compute a convolution based on the mapping.

31. The non-transitory computer-readable medium of any of clauses 25-29, further comprising program code to share the kernel between non-isomorphic edges via kernel canonization.
32. The non-transitory computer-readable medium of any of clauses 25-29, further comprising program code to share the kernel between non-isomorphic edges via tensor factorization.

As used, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed above comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method, comprising:
receiving a graph network comprising nodes connected by edges;
determining a node neighborhood for each of the nodes of the graph network and an edge neighborhood for each of the edges of the graph network;
classifying the node neighborhood for each of the nodes and the edge neighborhood for each of the edges based on isomorphism;
determining a mapping of a kernel from an edge neighborhood class representative to each of the edges of the graph network; and
generating a graph convolutional network based on the mapping.

2. The method of claim 1, further comprising:
selecting the edge neighborhood class representative for isomorphic edge neighborhoods of the graph network; and
selecting a node class representative for isomorphic node neighborhoods of the graph network.

3. The method of claim 2, further comprising:
arbitrarily labeling each node of the node class representative; and
identifying a second mapping of the node class representative to all neighborhoods in the node neighborhood class of the node class representative.

4. The method of claim 1, in which the mapping is determined by applying a kernel constraint for the edge neighborhood class representative.

5. The method of claim 4, in which node neighborhoods, edge neighborhoods, the node neighborhood class, the edge neighborhood class, and the kernel constraint for the edge neighborhood class representative are pre-determined based on a symmetry of a corresponding edge neighborhood.

6. The method of claim 1, further comprising receiving an input via the graph convolutional network and computing a convolution based on the mapping.

7. The method of claim 1, further comprising sharing the kernel between non-isomorphic edges via kernel canonization.

8. The method of claim 1, further comprising sharing the kernel between non-isomorphic edges via tensor factorization.

9. An apparatus, comprising:
a processor,
memory coupled with the processor; and
instructions stored in the memory and operable, when executed by the processor, to cause the apparatus:
to receive a graph network comprising nodes connected by edges;
to determine a node neighborhood for each of the nodes of the graph network and an edge neighborhood for each of the edges of the graph network;
to classify the node neighborhood for each of the nodes and the edge neighborhood for each of the edges based on isomorphism;
to determine a mapping of a kernel from an edge neighborhood class representative to each of the edges of the graph network; and
to generate a graph convolutional network based on the mapping.

10. The apparatus of claim 9, in which the instructions further cause the apparatus:
to select the edge neighborhood class representative for isomorphic edge neighborhoods of the graph network; and
to select a node class representative for isomorphic node neighborhoods of the graph network.

11. The apparatus of claim 10, in which the instructions further cause the apparatus:
to arbitrarily label each node of the node class representative; and
to identify a second mapping of the node class representative to all neighborhoods in the node neighborhood class of the node class representative.

12. The apparatus of claim 9, in which the instructions further cause the apparatus to determine the mapping by applying a kernel constraint for the edge neighborhood class representative.

13. The apparatus of claim 12, in which node neighborhoods, edge neighborhoods, the node neighborhood class, the edge neighborhood class, and the kernel constraint for the edge neighborhood class representative are pre-determined based on a symmetry of a corresponding edge neighborhood.

14. The apparatus of claim 9, in which the instructions further cause the apparatus:
to receive an input via the graph convolutional network; and
to compute a convolution based on the mapping.

15. The apparatus of claim 9, in which the instructions further cause the apparatus to share the kernel between non-isomorphic edges via kernel canonization.

16. The apparatus of claim 9, in which the instructions further cause the apparatus to share the kernel between non-isomorphic edges via tensor factorization.

17. An apparatus, comprising:
means for receiving a graph network comprising nodes connected by edges;
means for determining a node neighborhood for each of the nodes of the graph network and an edge neighborhood for each of the edges of the graph network;
means for classifying the node neighborhood for each of the nodes and the edge neighborhood for each of the edges based on isomorphism;
means for determining a mapping of a kernel from an edge neighborhood class representative to each of the edges of the graph network; and
means for generating a graph convolutional network based on the mapping.

18. The apparatus of claim 17, further comprising:
means for selecting the edge neighborhood class representative for isomorphic edge neighborhoods of the graph network; and
means for selecting a node class representative for isomorphic node neighborhoods of the graph network.

19. The apparatus of claim 18, further comprising:
means for arbitrarily labeling each node of the node class representative; and
means for identifying a second mapping of the node class representative to all neighborhoods in the node neighborhood class of the node class representative.

20. The apparatus of claim 17, further comprising means for applying a kernel constraint for the edge neighborhood class representative.

21. The apparatus of claim 20, in which node neighborhoods, edge neighborhoods, the node neighborhood class, the edge neighborhood class, and the kernel constraint for the edge neighborhood class representative are pre-determined based on a symmetry of a corresponding edge neighborhood.

22. The apparatus of claim 17, further comprising:
means for receiving an input via the graph convolutional network; and
means for computing a convolution based on the mapping.

23. The apparatus of claim 17, further comprising means for sharing the kernel between non-isomorphic edges via kernel canonization.

24. The apparatus of claim 17, further comprising means for sharing the kernel between non-isomorphic edges via tensor factorization.

25. A non-transitory computer-readable medium having program code recorded thereon, the program code being executed by an apparatus and comprising:
program code to receive a graph network comprising nodes connected by edges;
program code to determine a node neighborhood for each of the nodes of the graph network and an edge neighborhood for each of the edges of the graph network;
program code to classify the node neighborhood for each of the nodes and the edge neighborhood for each of the edges based on isomorphism;
program code to determine a mapping of a kernel from an edge neighborhood class representative to each of the edges of the graph network; and
program code to generate a graph convolutional network based on the mapping.

26. The non-transitory computer-readable medium of claim 25, further comprising:
program code to select the edge neighborhood class representative for isomorphic edge neighborhoods of the graph network; and
program code to select a node class representative for isomorphic node neighborhoods of the graph network.

27. The non-transitory computer-readable medium of claim 26, further comprising:
program code to arbitrarily label each node of the node class representative; and
program code to identify a second mapping of the node class representative to all neighborhoods in the node neighborhood class of the node class representative.

28. The non-transitory computer-readable medium of claim 25, further comprising program code to determine the mapping by applying a kernel constraint for the edge neighborhood class representative.

29. The non-transitory computer-readable medium of claim 28, in which node neighborhoods, edge neighborhoods, the node neighborhood class, the edge neighborhood class, and the kernel constraint for the edge neighborhood class representative are pre-determined based on a symmetry of a corresponding edge neighborhood.

30. The non-transitory computer-readable medium of claim 25, further comprising:
program code to receive an input via the graph convolutional network; and
program code to compute a convolution based on the mapping.
